(19) United States
(12) Patent Application Publication
(10) Pub. No.: US 2020/0372584 A1
(43) Pub. Date: Nov. 26, 2020

(54) Currency Tracking and Accounting Systems

(71) Applicant: JCM American Corporation, Las Vegas, NV (US)

(72) Inventor: David C. Kubajak, Las Vegas, NV (US)

(21) Appl. No.: 16/855,089

(22) Filed: Apr. 22, 2020

Related U.S. Application Data
(60) Provisional application No. 62/852,013, filed on May 23, 2019.

(51) Int. Cl. G06Q 40/00; G06Q 10/10; G06Q 30/00; G06Q 50/28; G06K 7/14; G08B 21/18

(52) U.S. Cl. CPC G06Q 40/12; G06Q 10/10; G08B 21/18; G06Q 50/28; G06K 7/1417; G06Q 30/0185

(57) ABSTRACT

Devices, systems and methods are provided to enable casino operators to track and account for printed casino currency items. In one example, a currency accounting system includes a currency scanner, a network communications interface, and a processor. The processor is configured to receive, from the currency scanner, an identifier of a printed casino currency item; transmit the identifier of the printed casino currency item via the network communications interface to a remote currency tracker; receive, via the network communications interface and in response to transmission of the identifier of the printed casino currency item, an identifier of a currency acceptance location through which the printed casino currency item passed; and generate a currency report using the identifier of the printed casino currency item and the identifier of the currency acceptance location.

### CROSS-REFERENCE TO RELATED APPLICATION

This application is a nonprovisional of and claims the benefit under 35 U.S.C. § 119(e) of U.S. Provisional Patent Application No. 62/852,013, filed May 23, 2019, the contents of which are incorporated by reference as if fully disclosed herein.

### FIELD

The technology described herein relates to devices, systems, and methods for use in tracking and accounting for printed casino currency items. The printed casino currency items may include, for example, treasury notes; bank notes; lottery tickets; coupons; ticket in, ticket out (TITO) cards; promotional coupons; sports betting slips; and so on.

### BACKGROUND

The operations of casinos, gaming devices, and gaming systems are typically tightly regulated by local, state and federal authorities. These regulations generally require a casino to maintain accurate records regarding every transaction that arises by, in or through the casino, and to maintain positive levels of control over all currency transactions. For example, casinos commonly include gaming machines, such as slot machines or gaming tables, or other devices, services, or systems, for which the casino is required by regulators to record and account for every provision of currency thereto. A casino patron typically provides currency items having a particular value to a casino, or to one or more of its gaming devices, employees, or other currency acceptors, in exchange for the opportunity of such patron (or others they may designate) to experience one or more games, products, or other services provided directly or indirectly by the casino.

### BRIEF DESCRIPTION OF THE DRAWINGS

The features, aspects, advantages, functions, components, devices, systems, and methods provided by the various embodiments of the present disclosure are further disclosed herein with regard to at least one of the following descriptions and accompanying drawing figures.

FIG. 1 shows an example networked system of currency acceptance locations (or devices), a currency tracking system, and a currency accounting system, for use in accordance with at least one embodiment of the present disclosure.

FIG. 2 shows a first example method of operating a currency tracking system, such as the currency tracking system described with reference to FIG. 1, in accordance with at least one embodiment of the present disclosure.

FIG. 3 shows a second example method of operating a currency tracking system, such as the currency tracking system described with reference to FIG. 1, in accordance with at least one embodiment of the present disclosure.

FIG. 4 shows a first example method of operating a currency accounting system, such as the currency accounting system described with reference to FIG. 1, in accordance with at least one embodiment of the present disclosure.

FIG. 5 shows a second example method of operating a currency accounting system, such as the currency accounting system described with reference to FIG. 1, in accordance with at least one embodiment of the present disclosure.

### DETAILED DESCRIPTION

The various embodiments described herein are directed to devices, systems and methods which are adaptable, accountable, and manageable by casino operators in the acceptance and dispensing of printed casino currency items (or other tangible casino currency items) for patron uses.

Described herein are devices, systems, and methods that can be used to scan and recognize the serial numbers or other identifiers of various currency items, and particularly, printed casino currency items received at currency acceptance locations (e.g., at electronic gaming machines (EGMs), gaming tables, currency validators (e.g., bill validators), automated teller machines (ATMs), or currency converters). Once an identifier of a currency item has been recognized, movement of the currency item within (or even outside) a casino may be tracked. For example, upon initial acceptance into a casino, an identifier of a currency item and the location of where it was accepted may be associated and forwarded to a currency tracking system. If the currency item is later dispensed, transferred to another location, or re-accepted at another location, the identifier of the currency item may be associated with these other locations as well, and the additional associations may be forwarded to the currency tracking system. If the currency item is ultimately forwarded to a currency accounting system, the locations where the currency item was accepted or dispensed may be retrieved from the currency tracking system.

In some cases, 1) an identifier of a currency acceptance location that is associated with the currency item and retrieved from a currency tracking system may be compared to 2) an identifier of a currency acceptance location associated with a currency container containing the currency item (e.g., a box or other container used to transport the currency item within a casino). If the identifiers of the currency acceptance locations match, the currency item may be considered properly accounted for. If the identifiers do not match, a casino system or casino employee may be notified of the discrepancy, and tampering with or mishandling of the currency item may be investigated.

The techniques described herein can automate currency handling and accounting to a greater degree than past devices, systems, and methods, and can eliminate the need for header/trailer cards in currency containers. The described techniques also provide for more granular currency item tracking—e.g., by currency item instead of by currency container.

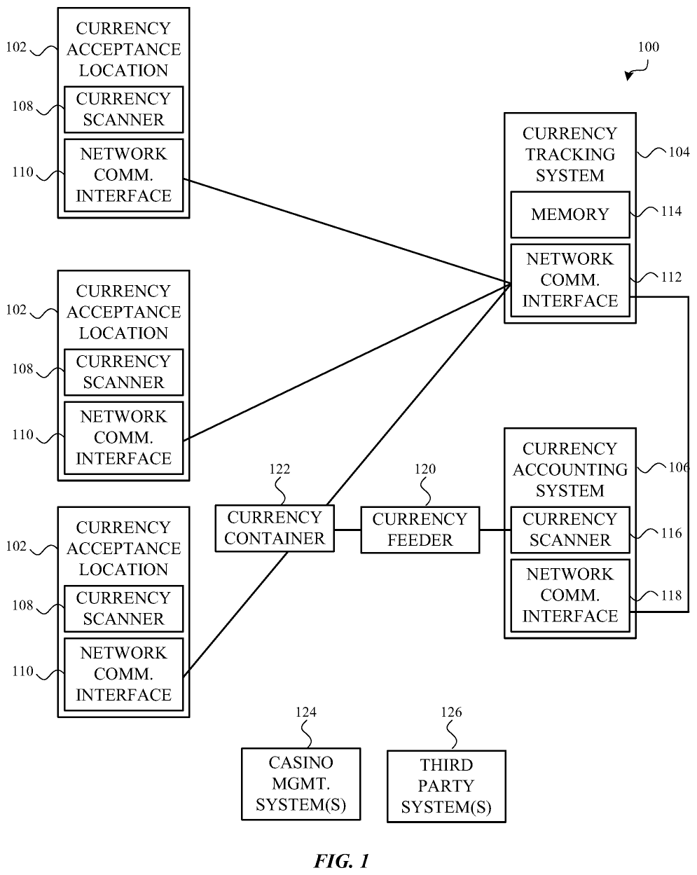

These and other techniques are described with reference to FIGS. 1-5. However, those skilled in the art will readily appreciate that the detailed description given herein with respect to these figures is for explanatory purposes only and should not be construed as limiting. The use of alternative terminology, such as “or”, is intended to indicate different combinations of the alternative elements or operations. For example, A or B is intended to include, A, or B, or A and B.

FIG. 1 shows a networked system 100 of currency acceptance locations 102, a currency tracking system 104, and a currency accounting system 106. The currency acceptance locations 102, currency tracking system 104, and currency accounting system 106 may be located within a casino, distributed across multiple casinos, or distributed across one or more casinos, one or more financial institutions, and one or more data centers or remote servers.

Each currency acceptance location 102 may include one or more currency acceptance devices, such as one or more EGMs, gaming tables, currency validators (e.g., bill validators), ATMs, or currency converters (e.g., machines that receive one type of currency (e.g., treasury notes, such as dollars or yen) and output another type of currency (e.g., a paper or plastic card storing an electronic, electromagnetic, or optical indicator of a currency type and value available to a user of the card).

An EGM may be configured to provide any desired patron/user experience. For example, in some embodiments, an EGM may include a slot machine that provides several rotating elements that, when aligned along one or more axes, trigger the dispensing of a prize and/or award to a casino patron. In other embodiments, an EGM may involve any other form of game of chance, such as a video poker game, a turn-based game (e.g., MONOPOLY™), or any other game or user experience. In at least one embodiment, an EGM may not involve any aspect of a game of chance and may instead involve the participation in activities desired by a patron, such as, for example, the opportunity to participate in a singing competition, the opportunity to view a video event, and so on. An EGM may additionally or alternatively provide any type of user desired interactive experience. An EGM may include any desired combination of hardware and software components, the type and capabilities of which are beyond the scope of the present disclosure.

In some cases, a currency acceptance location 102 may also function as a currency dispensing location. For example, a device configured to receive printed casino currency items through a slot may also dispense printed casino currency items through the slot, or through another slot.

Each of the currency acceptance locations 102 may include one or more currency scanners 108. Printed casino currency items (and in some cases, other currency items) received at a currency acceptance location 102 may be scanned by a currency scanner 108, tracked by the currency tracking system 104, and accounted for by the currency accounting system 106. The printed casino currency items may include, for example, treasury notes; bank notes; lottery tickets; coupons; TITO cards; promotional coupons; sports betting slips; and so on.

The currency scanners 108 may scan printed casino currency items and use optical character recognition (OCR) or other algorithms to recognize identifiers of the printed casino currency items. In some cases, an identifier of a printed casino currency item may include a serial number (e.g., a string of alphanumeric characters). An identifier of a printed casino currency item may also or alternatively include a pattern or other identifier. The serial number or pattern may be printed on the printed casino currency item, or, for example, the serial number or pattern may be physically, electronically, electromagnetically, optically, or holographically stored in or on the printed casino currency item.

Identifiers of printed casino currency items scanned at a currency acceptance location 102 may be associated with an identifier of the currency acceptance location 102. In some embodiments, an identifier of a currency acceptance location 102 may include an identifier of a currency acceptance device or currency scanner 108 used at the currency acceptance location 102. The associated identifiers may be transmitted via a network communications interface 110 of a currency acceptance location 102 to a network communications interface 112 of the currency tracking system 104. The network communications interfaces 110, 112 may include wired or wireless communications interfaces.

The currency tracking system 104 may receive and store associations between identifiers of printed casino currency items and identifiers of currency acceptance locations. The associations may be received via the network communications interface 112, from some or all of the currency acceptance locations 102. The associations may be stored in a data structure stored in a computer-readable memory 114 of the currency tracking system 104.

The currency accounting system 106 may include a currency scanner 116 and a network communications interface 118. Printed casino currency items that are received and scanned at the currency acceptance locations 102 may be transported to a location of the currency accounting system 106 and counted, sorted, or otherwise processed by the currency accounting system 106. In some cases, the printed casino currency items may be manually input into the currency accounting system 106. In some cases, the printed casino currency items may be semi-automatically input into the currency accounting system 106. For example, the currency accounting system 106 may include a currency feeder 120 that retrieves printed casino currency items from a currency container 122 (e.g., a cash box) and feeds the printed casino currency items into the currency scanner 116 of the currency accounting system 106. In some cases, the printed casino currency items may be returned to the currency container 122, or to a different currency container 122, after they are scanned (and potentially sorted or otherwise processed) by the currency accounting system 106.

In some embodiments, the currency accounting system 106 may transmit an identifier of a printed casino currency item to the currency tracking system 104. For example, the identifier may be transmitted via the network communications interface 118 of the currency accounting system 106 to the network communications interface 112 of the currency tracking system 104. The currency tracking system 104 may use the identifier of the printed casino currency item to retrieve an identifier of a currency acceptance location 102 through which the printed casino currency item passed. The identifier of the currency acceptance location may then be transmitted to the currency accounting system 106, and may be used, for example, to determine where the printed casino currency item was initially received into the system 100. The identifier of the currency acceptance location may also or alternatively be compared to another identifier of a currency acceptance location, which identifier is associated with the currency container 116 (e.g., an identifier of a currency acceptance location 102 where the currency container 122 was filled). In this manner, the comparison of identifiers may be used to determine whether an item that is accepted at a particular currency acceptance location 102 is transported to the currency accounting system 106 using an appropriate transport channel or protocol.

In some embodiments, the currency accounting system 106 may transmit an identifier of a currency acceptance location 102 to the currency tracking system 104. The identifier may be transmitted via the network communications interface 118 of the currency accounting system 106 to the network communications interface 112 of the currency tracking system 104. The currency tracking system 104 may use the identifier of the currency acceptance location to retrieve identifiers of a set of printed casino currency items accepted at the currency acceptance location 102. The identifiers may be transmitted to the currency accounting system 104, and may be used, for example, to determine whether the currency container 116 contains all of the printed casino currency items that were reported to the currency tracking system 104 as being accepted at the currency acceptance location 102.

Optionally, the system 100 may include one or more casino management systems 124. A casino management system 124 may perform any number of tasks, and in some cases may perform one or more of the following tasks: 1) enabling or disabling the currency acceptance locations 102, the currency tracking system 104, the currency accounting system 106, components thereof, or one or more other systems or devices of the system 100; 2) backing up data stored in one or more systems or devices of the system 100; 3) updating one or more systems or devices of the system 100; 4) collecting or authenticating data obtained from bioauthentication devices (e.g., fingerprint readers, facial scanners, and so on); 5) collecting data obtained from security devices (e.g., cameras); and so on. A casino management system 124 may be connected to other systems or devices (e.g., to currency acceptance locations 102, the currency tracking system 104, or the currency accounting system 106) via wired and/or wireless communication links.

The system 100 may also optionally include one or more third party systems 126. The third party systems 126 may differ from the casino management systems 124 in that they may have different access rights for obtaining data from or controlling other systems or devices within a casino. For example, a casino management system 124 may have greater access rights than a third party system 126. In other examples, a third party system 126 may have greater access rights than some casino management systems 124. In some cases, a casino management system 124 may be implemented, in whole or in part, as a third party system 126. Examples of third party systems 126 include systems that manage security, audit financial systems, backup data, and so on. A third party system 126 may be connected to other systems or devices (e.g., to currency acceptance locations 102, the currency tracking system 104, or the currency accounting system 106) via wired and/or wireless communication links.

In some embodiments, a third party system 126 (or even a casino management system 124) may be installed or deployed remotely from a casino. In some embodiments, either or both of the currency tracking system 104 or the currency accounting system 106 may be implemented, in whole or in part, as a casino management system 124 or a third party system 126.

Each of the currency acceptance locations 102, currency tracking system 104, currency accounting system 106, casino management systems 124, and third party systems 126 may include a processor for controlling the functions thereof. The processor may be a singular processor (e.g., a microprocessor, an application-specific integrated circuit (ASIC), or a microcontroller), or the functions of the processor may be performed by a set of processors or sub-processors that perform the same or different functions. In some embodiments, a currency acceptance location 102 including an EGM may include a slot machine interface board (SMIB) or other peripheral controller that controls operation of the EGM's currency scanner 108, network communications interface 110, and/or other components or devices housed with the EGM (e.g., in a gaming cabinet of the EGM).

It is to be appreciated that the communications paths and/or linkages utilized to communicatively couple each of the currency scanner 108, network communications interface 110, processor, or other components installed at a currency acceptance location 102 may utilize any desired medium, such as copper wire, printed circuit boards, optical cables, wireless pathways, physical connectors, or otherwise. In at least one embodiment, RS-232 compatible communication components may be utilized to communicatively couple other components or devices installed at a currency acceptance location 102. In at least one embodiment, universal serial bus (USB) compatible communication components may be utilized to communicatively couple other components or devices installed at a currency acceptance location 102. In other embodiments, any known or hereafter developed communications components may be utilized to communicatively couple some or all of the components or devices installed at a currency acceptance location 102. Further, in at least one embodiment, the communications components utilized to communicatively couple other components or devices installed at a currency acceptance location 102 may utilize a single medium, with the data signals communicated between such devices being separated, interleaved, addressed, or otherwise communicated. In short, any known or hereafter developed communications technologies may be used to communicatively couple one or more components or devices installed at a currency acceptance location 102. Such technologies may also be configured, as desired for any given embodiment, to facilitate the removal and replacement of one or more components installed at a currency acceptance location, as such needs may arise, for repair, updating, and so on. The same or different types of communication components may be used to couple the memory 114, network communications interface 112, processor, or other components installed in the currency tracking system 104, or to couple the currency scanner 116, network communications interface 118, processor, or other components installed in the currency accounting system 106.

A currency scanner 108 or 116 (e.g., a bill validator) may be configured to operate in accordance with one or more system protocols. Such protocols may be configured, for example, to govern when a currency scanner 108 or 116 can and cannot be utilized. Embodiments of such system protocols are discussed below. A currency scanner 108 or 116 may be configured to detect the presence of any desired form of currency item, or other provisioning of data. In at least one embodiment, a currency scanner 108 or 116 may be configured to receive information printed using known techniques. By way of illustration only and not by means of limitation, examples of such techniques include serial numbers, two-dimensional bar codes, QR codes, data matrices, digital paper codes, visible and invisible watermarks, magnetically encoded information, and so on. In at least one embodiment, a currency scanner 108 or 116 may be configured to receive other forms of information provided on “tickets” such as a patron's signature, a code, or another identifier provided by a patron. A currency scanner 108 or 116 may be configured to include optical character recognition capabilities, pattern recognition capabilities and other forms of signal and character processing technologies. A currency scanner 108 or 116 may be configured to receive data communicated by means of electrical, optical and/or radio frequency signals, such as near field communication (NFC) signals, Wi-Fi signals, and using other known technologies. It is to be appreciated that any known device may provide such data. Examples of such devices include RFID tags, smart phone systems and others. A currency scanner 108 or 116 may be configured to determine, based on the origin and/or type of information received from a given currency item or device providing the same, where such information is to be communicated. For example, in accordance with at least one embodiment, the insertion of a currency item into currency scanner 108 or 116 may cause the currency scanner 108 or 116 to verify the authenticity of such currency item and, when authentic, communicate the issuing authority, amount, serial number, and any other desired information to an EGM or currency tracking system 104.

In accordance with at least one embodiment, the currency scanner 108 or 116 may be configured to include one or more premium features. Such configurations may be managed using an Enhanced Services system server, a casino management system having Enhanced Services system capabilities, or otherwise. In accordance with at least one embodiment, a premium feature provided by a currency scanner 108 or 116 may include the capability to receive, validate and accept currencies provided in multiple currencies, and communicate to a casino management system or the currency tracking system 104, the issuing authority and type, e.g., U.S. dollars versus British Pounds Sterling, serial numbers, and/or values of the currency items received. The currency scanner 108 or 116, separately, or in conjunction with the Enhanced Services system and/or the casino management system, may be configured to customize the currency exchange rates utilized, prizes awarded as based upon a desired currency, provide currency conversions with or without a markup, and/or provide other financial transactions. The currency scanner 108 or 116 and system 100 may also be configured to consider differences in currency exchange rates, a player's native currency (i.e., the primary currency utilized where they reside), the amount won in the currency local to the casino and other factors in determining amounts to record and/or report in compliance with one or more tax reporting requirements. It is to be appreciated that the features provided may be standardized or customized for one or more validators, casino systems, type of currency items received or otherwise. Currency scanners 108 or 116 may also be customized to receive and recognize one or more tickets, such as lottery tickets, coupons, cashier's checks, or otherwise. Such customization may occur under the direction and direct or indirect control of an Enhanced Services system server, a casino management system server, a combination of the foregoing, or otherwise. At least one embodiment includes the use of a currency scanner 108 or 116 having operating software and/or other routines or functions that may be upgraded and/or downloaded from a casino system server, such as an Enhanced Services system server. A currency scanner 108 or 116 may be identified by a unique identifier, such as a network address, a device hardware identifier, unique sequence of numbers, by a group, such as a grouping of two or more currency scanners in a casino system, or otherwise. A currency scanner 108 or 116 may be configured to accumulate, monitor, and provide various metrics about scanner usage including, for example, usage data, type of currency items (including tickets) received, device health, status, or other parameters commonly used to monitor validators in casino systems. For at least one embodiment, a currency scanner 108 or 116 may be configured to provide back-tracing capabilities that enable a casino operator using, for example, an Enhanced Services system server and/or a casino management system server, to obtain banknote signatures, serial number OCR, and for back-tracing an inserted banknote to a specific player. In accordance with such an embodiment, casino system may be utilized to monitor and deter the use of forged currencies and other illicit negotiable instruments.

In accordance with at least one embodiment, a currency scanner 108 or 116 may be configured to include an Image Correction and Enhancement (ICE) component. The ICE component may be configured to provide for advanced character recognition capabilities that may be uniquely associated with unique and/or generic brands of validators, such as the iVIZION validator provided by Japan Cash Machine Co., Ltd.

It is to be appreciated that the storage and/or communication of data by and between any of the components of the system 100 may be encrypted. Any desired single encryption technology, or combination of encryption technologies, may be utilized by the system 100 components, including but not limited to the use of secure socket layers, virtual private networking, public/private keys, 256-bit encryption algorithms, or other known or later arising encryption algorithms, techniques and technologies.

It is also to be appreciated that in accordance with at least one embodiment, any two or more of the networked system components may be logically, physically, or virtually directly communicatively coupled. Such couplings may include the use of one or more software application program interfaces (APIs), such that API calls between any two given server components may be utilized to authorize, access, control or otherwise manage one or more services provided by the system. In some embodiments, a casino management system 124 or third party system 126 may be communicatively coupled to the currency tracking system 104 or currency accounting system 106 by a wired or hard line connection (e.g., a serial, USB, or wired network connection), a wireless connection (e.g., a Wi-Fi, NFC, or Bluetooth Low Energy (BLE) connection), or a software API, to provide the casino management system 124 or third party system 126 with access to the data stored, tracked, or derived by the currency tracking system 104 or currency accounting system 106.

A casino management system 124 or third party system 126 may access the data stored, tracked, or derived by the currency tracking system 104 or currency accounting system 106 for various purposes, which purposes may be specified and limited by a casino operator or other personnel. For example, a casino management system 124 or third party system 126 that provides a security or surveillance function may access data stored or derived by the currency tracking system 104 and/or currency accounting system 106 for the purpose of monitoring or determining the path that a currency item follows within a casino, or to determine or follow the currency item(s) involved in a user transaction or gaming transaction. In some cases, a casino management system 124 or third party system 126 may operate a positioning system attached to a camera, to obtain surveillance footage (e.g., live footage) of a casino patron that recently input a currency item into a currency scanner 108; or the casino management system 124 or third party system 126 may retrieve surveillance footage (e.g., stored footage) that was obtained at or around the time the currency item was input into the currency scanner 108 (e.g., for performing an investigation into fraudulent or otherwise criminal behavior).

A casino management system 124 or third party system 126 may also (or alternatively) monitor information stored or tracked by the currency tracking system 104 for the purpose of determining when or where a particular currency item, or dummy currency item, is received into the system 100, or for the purpose of following a particular currency item or dummy currency item. In some embodiments, the casino management system 124 or third party system 126 may trigger one or more alerts upon identifying an acceptance or dispensing of the particular currency item or dummy currency item.

A casino management system 124 or third party system 126 may also (or alternatively) access information that is stored, tracked, or derived by the currency tracking system 104 or currency accounting system 106 for the purpose of determining the flow of currency items and helping a casino operator, financial institution, governmental entity, or the authorities determine whether and where a crime, such as theft or fraud, occurred within a casino (and in some cases, by whom). For example, a casino management system 124 or third party system 126 may execute logical decisions, or use artificial intelligence (AI) or other learning algorithms, to determine casino patron behavior or identify transaction patterns, and use the determined behavior or patterns to, for example, 1) disable the use of devices that the casino patron may attempt to use, such as a kiosk, EGM, ATM, currency acceptor, bill validator, point-of-sale (POS) device, deposit or money transfer function, ticket printer, cash dispenser, and so on; 2) obtain live footage or biometrics of a casino patron engaging in criminal or suspicious behavior; or 3) automatically confiscate (e.g., by operation of controlling the feed mechanism for a currency scanner) a TITO card, currency item, or other item received from a casino patron engaging in criminal or suspicious behavior.

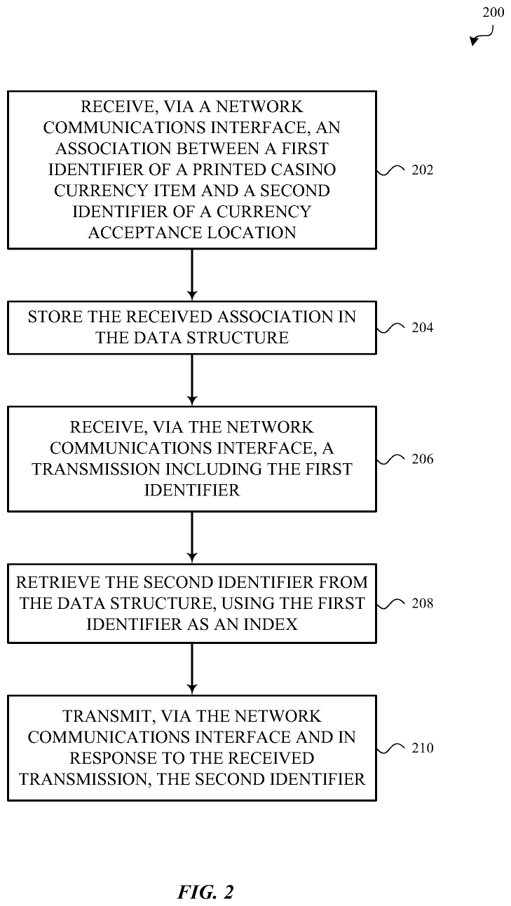

Each of the currency acceptance locations 102, currency tracking system 104, and currency accounting system 106 may also or alternatively perform other functions, as described, for example, with reference to FIGS. 2-5.

FIG. 2 shows a method 200 of operating a currency tracking system such as the currency tracking system described with reference to FIG. 1. The operations of the method 200 may be performed, in whole or in part, by a processor of the currency tracking system.

At block 202, the method 200 may include receiving, via a network communications interface of the currency tracking system, an association between a first identifier of a printed casino currency item and a second identifier of a currency acceptance location. In some cases, the first identifier may include a serial number. The first identifier may also or alternatively include a pattern or other identifier. In some embodiments, the second identifier may include an identifier of a currency acceptance device or currency scanner that is used at the currency acceptance location.

In some cases, the association between the first and second identifiers may be received from a currency acceptance device (or other device associated with a currency acceptance location). The association may be received as a singular association, or as part of a batch or stream communication that includes many such associations. For example, a currency acceptance device may transmit a set of multiple identifiers of printed casino currency, with each of the multiple identifiers being associated with an identifier of the currency acceptance device or its location. A currency acceptance device may also transmit different associations (or set of associations) in different communications (e.g., at different times).

The network communications interface may include any number of physical network connectors, or wired, wireless, or virtual ports. The network communications interface may support one or multiple wired or wireless communications protocols. In some cases, data may be received or transmitted over multiple ports in parallel, to/from the same or different receivers/transmitters.

At block 204, the method 200 may include storing the received association. The received association may be stored in a data structure that associates identifiers of printed casino currency items with identifiers of currency acceptance locations. The data structure may be an integrated data structure (e.g., a singular database or table) or a distributed data structure (e.g., a collection of databases or tables). The data structure may be stored in computer-readable memory provided, for example, by one or more memory modules, storage devices, and so on. In some embodiments, the data structure may also be used to store associations between identifiers of printed casino currency items and identifiers of currency dispensing locations. The data structure may also store timestamps associated with received associations or other information.

At block 206, the method 200 may include receiving, via the network communications interface, a transmission including the first identifier (i.e., the identifier of the printed casino currency item).

At block 208, and using the first identifier as an index, the method 200 may include retrieving the second identifier (i.e., the identifier of the currency acceptance location) from the data structure.

At block 210, the method 200 may include transmitting the second identifier via the network communications interface, in response to the received transmission. In some cases, this may include transmitting the second identifier to the device that transmitted the first identifier received at block 206 (e.g., the second identifier may be transmitted as a response to a query received at block 206).

The operations of the method 200 need not be performed at or about the same time. For example, the operations performed at blocks 202 and 204 may be performed as part of, or in relation to, an information logging and tracking function; and the operations performed at blocks 206, 208, and 210 may be performed as part of, or in response to, a query response function. The information logging and tracking function and query response function may be performed in series or in parallel, in response to information received from one or many currency tracking locations, and in response to queries received from one or many currency accounting systems. In some cases, the operations performed at blocks 202 and 204 may be considered to define part or all of a method that is separate from the method defined at least partly by the operations performed at blocks 206, 208, and 210.

The currency tracking system may receive and store any number of associations between identifiers of printed casino currency items and identifiers of currency acceptance locations. For example, the association between the first and second identifiers may be a first association, between a first printed casino currency identifier and a first currency acceptance location. A processor performing the method 200 may further receive, for example, a second association, between a third identifier and the second identifier (with the third identifier being an identifier of a second printed casino currency item). The second association may therefore indicate that another printed casino currency item has been received at the currency acceptance location identified by the second identifier.

The processor performing the method 200 may also or alternatively receive, for example, a third association, between a fourth identifier and a fifth identifier (with the fourth identifier being an identifier of a third printed casino currency item, and the fifth identifier being an identifier of a second currency acceptance location). The first and third associations may therefore indicate that different printed casino currency items were received at different currency acceptance locations.

The processor performing the method 200 may also or alternatively receive, for example, a fourth association, between the first identifier and the fifth identifier. Timestamps associated with the first and fourth associations may indicate that the first printed casino currency item was received at the first currency acceptance location, then the second currency acceptance location. Still further, or alternatively, the processor performing the method 200 may receive, for example, a fifth association, between the first identifier and a sixth identifier (with the sixth identifier being an identifier of a currency dispensing location). Timestamps associated with the first, fourth, and fifth associations may indicate that the first printed casino currency item was received at the first currency acceptance location, dispensed from the currency dispensing location, and then received at the second currency acceptance location.

Any or all of the above types of associations may be stored in the same or different data structures at (or by) the currency tracking system.

When a currency tracking system performing the method 200 receives an identifier of a printed casino currency item, and the identifier is associated with more than one currency acceptance locations or currency dispensing locations, an identifier of a currency acceptance location or currency dispensing location at which the printed casino currency item was last received or dispensed may be transmitted in response to receiving the identifier of the printed casino currency item. Alternatively, a history (or recent history) of where the printed casino currency item has been accepted or dispensed may be transmitted in response to receiving the identifier of the printed casino currency item. More generally, at least one of the identifiers of a currency acceptance location or currency dispensing location associated with the identifier of the printed casino currency item may be transmitted in response to receiving the identifier of the printed casino currency item.

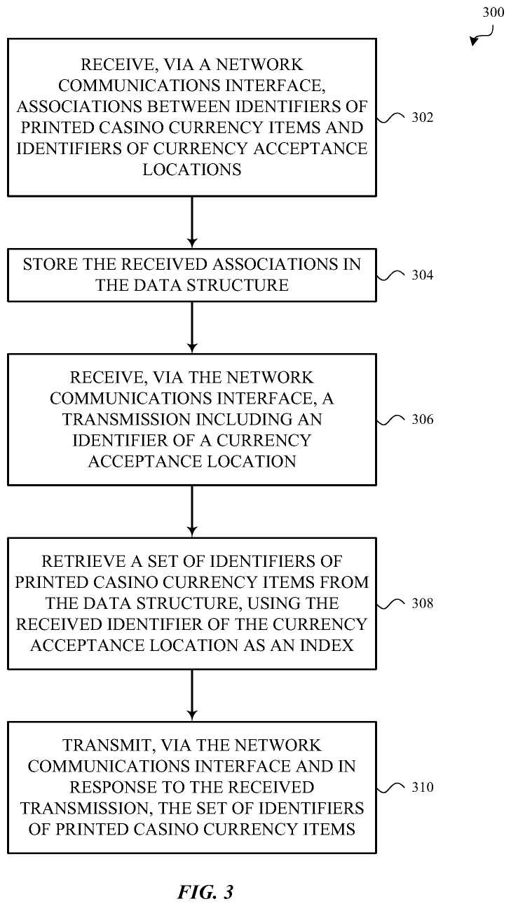

FIG. 3 shows another method 300 of operating a currency tracking system such as the currency tracking system described with reference to FIG. 1. The operations of the method 300 may be performed, in whole or in part, by a processor of the currency tracking system.

At block 302, the method 300 may include receiving, via a network communications interface of the currency tracking system, associations between identifiers of printed casino currency items and identifiers of currency acceptance locations at which the printed casino currency items are received. In some cases, the identifiers of the printed casino currency items may include serial numbers. The identifier may also or alternatively include patterns or other identifiers. In some embodiments, the identifiers of the currency acceptance locations may include identifiers of currency acceptance devices or currency scanners that are used at the currency acceptance locations.

In some cases, the associations between identifiers may be received from currency acceptance devices (or other devices associated with currency acceptance locations). The associations may be received as singular associations, or as part of a batch or stream communication that includes many such associations. For example, a currency acceptance device may transmit a set of multiple identifiers of printed casino currency, with each of the multiple identifiers being associated with an identifier of the currency acceptance device or its location. A currency acceptance device may also transmit different associations (or set of associations) in different communications (e.g., at different times).

The network communications interface through which the associations of identifiers are received may include any number of physical network connectors, or wired, wireless, or virtual ports. The network communications interface may support one or multiple wired or wireless communications protocols. In some cases, data may be received or transmitted over multiple ports in parallel, to/from the same or different receivers/transmitters.

At block 304, the method 300 may include storing the received associations. The received associations may be stored in a data structure that associates identifiers of printed casino currency items with identifiers of currency acceptance locations. The data structure may be an integrated data structure (e.g., a singular database or table) or a distributed data structure (e.g., a collection of databases or tables). The data structure may be stored in computer-readable memory provided, for example, by one or more memory modules, storage devices, and so on. In some embodiments, the data structure may also be used to store associations between identifiers of printed casino currency items and identifiers of currency dispensing locations. The data structure may also store timestamps associated with received associations or other information.

At block 306, the method 300 may include receiving, via the network communications interface, a transmission including an identifier of a currency acceptance location.

At block 308, and using the identifier received at block 306 as an index, the method 300 may include retrieving, from the data structure, a set of identifiers of printed casino currency items.

At block 310, the method 300 may include transmitting the set of identifiers via the network communications interface, in response to the received transmission. In some cases, this may include transmitting the set of identifiers to the device that transmitted the identifier received at block 306 (e.g., the set of identifiers may be transmitted as a response to a query received at block 306).

The operations of the method 300 need not be performed at or about the same time. For example, the operations performed at blocks 302 and 304 may be performed as part of, or in relation to, an information logging and tracking function; and the operations performed at blocks 306, 308, and 310 may be performed as part of, or in response to, a query response function. The information logging and tracking function and query response function may be performed in series or in parallel, in response to information received from one or many currency tracking locations, and in response to queries received from one or many currency accounting systems. In some cases, the operations performed at blocks 302 and 304 may be considered to define part or all of a method that is separate from the method defined at least partly by the operations performed at blocks 306, 308, and 310.

The currency tracking system may receive and store any number of associations between identifiers of printed casino currency items and identifiers of currency acceptance locations, as described with reference to FIG. 2.

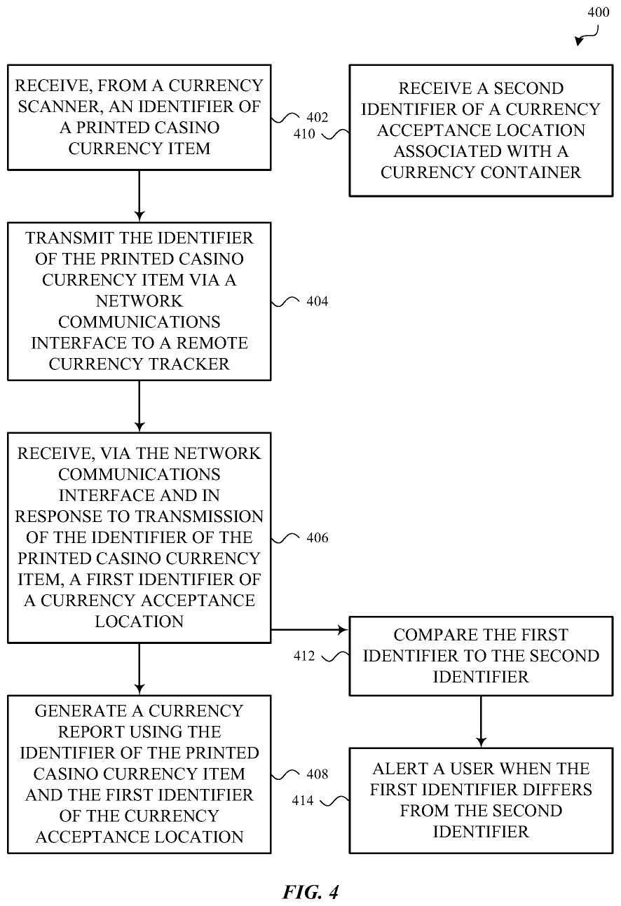

FIG. 4 shows a method 400 of operating a currency accounting system such as the currency accounting system described with reference to FIG. 1. The operations of the method 400 may be performed, in whole or in part, by a processor of the currency accounting system.

At block 402, the method 400 may include receiving, from a currency scanner, an identifier of a printed casino currency item. In some cases, the identifier may include a serial number. The identifier may also or alternatively include a pattern or other identifier.

At block 404, the method 400 may include transmitting the identifier of the printed casino currency item, via a network communications interface, to a remote currency tracker (e.g., to the currency tracking system described with reference to FIG. 1). The network communications interface may include any number of physical network connectors, or wired, wireless, or virtual ports. The network communications interface may support one or multiple wired or wireless communications protocols. In some cases, data may be received or transmitted over multiple ports in parallel, to/from the same or different receivers/transmitters.

At block 406, the method 400 may include receiving, via the network communications interface and in response to transmission of the identifier of the printed casino currency item, an identifier of a currency acceptance location through which the printed casino currency item passed. In some embodiments, the identifier of the currency acceptance location may include an identifier of a currency acceptance device or currency scanner that is used at the currency acceptance location.

At block 408, the method 400 may include generating a currency report using the identifier of the printed casino currency item and the identifier of the currency acceptance location. In some embodiments, the report may be or include a report that identifies the currency acceptance location where the printed casino currency item was accepted. In some embodiments, the report may be or include a reconciliation report that identifies a discrepancy (or lack of discrepancy) between the identifier of the currency acceptance location received at block 406 (e.g., a first identifier of a currency acceptance location) and a second identifier of a currency acceptance location (e.g., an identifier received with the printed casino currency item). To generate such a reconciliation report, the operations at optional blocks 410, 412, and 414 may be performed.

At block 410, the method 400 may include receiving an identifier of a currency acceptance location. The identifier may be an identifier associated with a currency container from which the printed casino currency item is obtained to scan it, for purposes of obtaining the identifier of the printed casino currency item at block 402.

At block 412, the method 400 may include comparing the identifier of a currency acceptance location received at block 406 (i.e., a first identifier) to the identifier of a currency acceptance location received at block 410 (i.e., a second identifier).

At block 414, the method 400 may include alerting a user when the first identifier differs from the second identifier—a scenario that may indicate the printed casino currency item was tampered with or mishandled subsequent to being accepted by a currency acceptance location. In some embodiments, the alert may be provided in the report generated at block 408. In some embodiments, the alert may be additionally or alternatively provided by an audible alarm, a visual display, or another means.

In some embodiments of the method 400, identifiers for a plurality of printed casino currency items may be received at block 402, and a plurality of identifiers may be transmitted at block 404. In these embodiments, an identifier of one or more currency acceptance locations may be received at block 406. For example, a separate identifier of a currency acceptance location may be received for each identifier of a printed casino currency item transmitted at block 404. Alternatively, a single identifier may be received when each of the identifiers of a printed casino currency item is determined to be associated with the same currency acceptance location. Or, when a first subset of identifiers of printed casino currency items is associated with a first currency acceptance location, and a second subset of identifiers of printed casino currency items is associated with a second currency acceptance location, identifiers of each of the currency acceptance locations may be received, with an indication of which identifiers of printed casino currency items are associated with which identifier of a currency acceptance location.

In the embodiments described in the preceding paragraph, the method 400 may further include determining a total value of the plurality of printed casino currency items. Additionally or alternatively, the method 400 may include sorting the plurality of printed casino currency items by at least one of: denomination value; printed casino currency type; or currency acceptance location. In some cases, the sorted items may be returned to a currency container from which they were retrieved, or to a different currency container.

Additionally or alternatively, the method 400 may include alerting a user when different printed casino currency items in the plurality of printed casino currency items have passed through different currency acceptance locations (e.g., in scenarios in which they are expected to have passed through the same currency acceptance location). The method 400 may also or alternatively include alerting a user when a currency acceptance location is not received (at block 406) for an item in the plurality of printed casino currency items. The alert(s) may be provided in the report generated at block 408. The alert(s) may be additionally or alternatively be provided by audible alarms, visual displays, or other means.

In some embodiments of the method 400, the method 400 may include receiving, at block 406 and in response to the transmission of the identifier of the printed casino currency item, identifiers of at least two currency acceptance locations and at least one currency dispensing location through which the printed casino currency item passed. In these embodiments, the currency report generated at block 408 may be generated using the identifiers of the at least two currency acceptance locations and at least one currency dispensing location. For example, all of the currency accepting and dispensing locations may be listed in the currency report and associated with the identifier of the printed casino currency item. Alternatively, timestamps associated with the various currency accepting and dispensing locations may be checked, and only a most recent currency accepting location may be included in the currency report. The locations may also be used or presented in different ways.

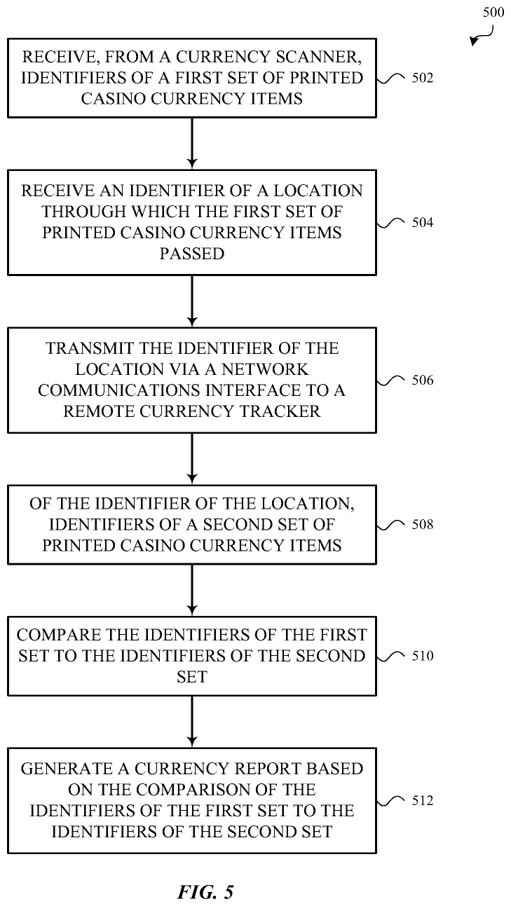

FIG. 5 shows another method 500 of operating a currency accounting system such as the currency accounting system described with reference to FIG. 1. The operations of the method 500 may be performed, in whole or in part, by a processor of the currency accounting system.

At block 502, the method 500 may include receiving, from a currency scanner, identifiers of a first set of printed casino currency items. In some cases, the identifiers may include serial numbers. The identifiers may also or alternatively include patterns or other identifiers.

At block 504, the method 500 may include receiving an identifier of a location through which the printed casino currency items passed. The identifier may be an identifier associated with a currency container from which the printed casino currency items are retrieved to scan them, for purposes of obtaining the identifiers of the printed casino currency items at block 502. In some embodiments, the identifier of the location or currency container may include an identifier of a currency acceptance location at which the printed casino currency items were received (and at which the currency container was filled).

At block 506, the method 500 may include transmitting, through a network communications interface, the identifier of the location through which the printed casino currency items passed. The identifier may be transmitted to a remote currency tracker (e.g., currency tracking system described with reference to FIG. 1). The network communications interface may include any number of physical network connectors, or wired, wireless, or virtual ports. The network communications interface may support one or multiple wired or wireless communications protocols. In some cases, data may be received or transmitted over multiple ports in parallel, to/from the same or different receivers/transmitters.

At block 508, the method 500 may include receiving, via the network communications interface and in response to transmission of the identifier of the location through which the printed casino currency items passed, identifiers of a second set of printed casino currency items. The identifiers of the second set of printed casino currency items include identifiers that were transmitted from the currency acceptance location to the remote currency tracker.

At block 510, the method 500 may include comparing the identifiers of the first set to the identifiers of the second set.

At block 512, the method 500 may include generating a currency report based on the comparison of the identifiers of the first set to the identifiers of the second set. The report may identify a mismatch (i.e., discrepancies), or alternatively a lack of discrepancies, between the first and second sets of identifiers—a scenario that may indicate one or more printed casino currency items were tampered with or mishandled subsequent to being accepted by the currency acceptance location. In some embodiments, the report may include a user alert, or an alert may be additionally or alternatively provided by an audible alarm, a visual display, or another means.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

1. A currency accounting system, comprising:
a currency scanner;
a network communications interface; and
a processor configured to:
receive, from the currency scanner, an identifier of a printed casino currency item;
transmit the identifier of the printed casino currency item via the network communications interface to a remote currency tracker;
receive, via the network communications interface and in response to transmission of the identifier of the printed casino currency item by the processor, an identifier of a currency acceptance location through which the printed casino currency item passed; and
generate a currency report using the identifier of the printed casino currency item and the identifier of the currency acceptance location.

2. The currency accounting system of claim 1, further comprising:
a currency feeder configured to retrieve the printed casino currency item from a currency container and feed the printed casino currency item into the currency scanner.

3. The currency accounting system of claim 2, wherein:
the identifier of the currency acceptance location comprises a first identifier; and
the processor is further configured to:
receive a second identifier of a currency acceptance location associated with the currency container;
compare the first identifier to the second identifier; and
alert a user when the first identifier differs from the second identifier.

4. The currency accounting system of claim 1, wherein the processor is configured to:
receive, and transmit via the network communications interface, identifiers of a plurality of printed casino currency items; and
receive, via the network communications interface, an identifier of one or more currency acceptance locations through which the plurality of printed casino currency items passed.

5. The currency accounting system of claim 4, wherein the processor is further configured to determine a total value of the plurality of printed casino currency items.

6. The currency accounting system of claim 4, wherein the processor is further configured to sort the plurality of printed casino currency items by at least one of: denomination values; printed casino currency types; or currency acceptance locations.

7. The currency accounting system of claim 4, wherein the processor is configured to alert a user when different printed casino currency items in the plurality of printed casino currency items have passed through different currency acceptance locations.

8. The currency accounting system of claim 4, wherein the processor is configured to alert a user when a currency acceptance location is not received for an item in the plurality of printed casino currency items.

9. The currency accounting system of claim 1, wherein:
the processor is configured to:
receive, via the network communications interface and in response to the transmission of the identifier of the printed casino currency item, identifiers of at least two currency acceptance locations and at least one currency dispensing location through which the printed casino currency item passed; and
generate the currency report using the identifiers of the at least two currency acceptance locations and the at least one currency dispensing location.

10. The currency accounting system of claim 1, wherein the identifier of the printed casino currency item comprises a serial number.

11. The currency accounting system of claim 1, wherein the identifier of the currency acceptance location comprises an identifier of a currency acceptance device or currency scanner.

12-20. (canceled)

21. The currency accounting system of claim 1, wherein:
the identifier of the currency acceptance location comprises a first identifier; and
the processor is further configured to:
receive a second identifier of a currency acceptance location associated with a currency container from which the printed casino currency item is retrieved;
compare the first identifier to the second identifier; and
alert a user when the first identifier differs from the second identifier.

22. The currency accounting system of claim 21, wherein the currency container comprises a cash box.

23. The currency accounting system of claim 1, wherein the printed casino currency item comprises at least one of:
a treasury note;
a bank note;
a lottery ticket;
a coupon;
a ticket-in, ticket-out card;
a promotional coupon; or
a sports betting slip.

24. The currency accounting system of claim 1, wherein the identifier of the printed casino currency item comprises a pattern.

25. The currency accounting system of claim 1, wherein the identifier of the printed casino currency item is at least one of:
physically stored on the printed casino currency item;
electronically stored on the printed casino currency item;
electromagnetically stored on the printed casino currency item;
optically stored on the printed casino currency item; or
holographically stored on the printed casino currency item.

26. A currency accounting system, comprising:
a network communications interface; and
a processor configured to:
receive an identifier of a printed casino currency item;
in response to transmitting the identifier of the printed casino currency item via the network communications interface to a remote currency tracker, receive an identifier of a currency acceptance location at which the printed casino currency item was accepted; and
generate a currency report using the identifier of the printed casino currency item and the identifier of the currency acceptance location.

27. The currency accounting system of claim 26, wherein the currency acceptance location comprises at least one of:
an electronic gaming machine;
a gaming table;
a currency validator;
a bill validator;
an automated teller machine; or
a currency converter.

28. A currency accounting system, comprising:
a currency scanner; and
a processor configured to:
receive, from the currency scanner, an identifier of a printed casino currency item;
in response to transmitting the identifier of the printed casino currency item to a remote currency tracker, receive an identifier of a currency acceptance location that accepted the printed casino currency item; and
generate a currency report using the identifier of the printed casino currency item and the identifier of the currency acceptance location.

29. The currency accounting system of claim 28, wherein the identifier of the printed casino currency item comprises at least one of:
a two-dimensional bar code;
a quick response code;
a data matrix;
a digital paper code;
a watermark; or
magnetically encoded information.
